(19) United States
(12) Patent Application Publication
(10) Pub. No.: US 2011/0299813 A1
(43) Pub. Date: Dec. 8, 2011

(54) High speed optical interconnects

(76) Inventor: William H. Southwell, Thousand Oaks, CA (US)

(21) Appl. No.: 13/134,328

(22) Filed: Jun. 3, 2011

Related U.S. Application Data
(60) Provisional application No. 61/396,894, filed on Jun. 4, 2010.

(51) Int. Cl. G02B 6/26

(52) U.S. Cl. 385/39

(57) ABSTRACT

An optical interconnect that uses silver, gold, copper or other materials whose refractive index n is less than unity as the transmitting media has been conceived. This optical interconnect will transfer information over short distances faster than electrical conduction and faster than free-space optical transmission. The transfer speed is many times the free-space speed of light.

### CROSS-REFERENCE TO RELATED APPLICATIONS

Provisional application No. 61/396,894 filed on Jun. 04, 2010.

### STATEMENT REGARDING FEDERALLY SPONSORED RESEARCH OR DEVELOPMENT

This invention was made with Government support under contract F36615-03-D-5408 awarded by U.S. Air Force to General Dynamics Information Technology, Inc. who subcontracted to Table Mountain Optics under Task Order No. USAF-5408-23-SC-0010-1 Modification #001. The Government has certain rights in the invention.

### FIELD OF THE INVENTION

This invention relates to optical interconnects for chip-to-chip communication. In particular it relates to the use of materials that propagate light faster than the speed of light in optical fibers or even faster than free-space light transmission.

### BACKGROUND OF THE INVENTION

As described by Li in U.S. Pat. No. 6,661,943, state of the art microelectronic systems commonly employ multichip modules. A multichip module includes an array of integrated circuit chips that require signal interconnections between the chips. Next-generation computational systems require ever increasing speeds. Using shorter interconnect path lengths and increasing the speed of information over that path are ways to enhance speed.

### BRIEF SUMMARY OF THE INVENTION

An optical interconnect that passes information between chips faster than electrical or optical fibers or waveguides has been invented. This interconnect uses silver or some other metal or Nitride to transmit the light between chips. It has been discovered that light travels faster than c, which is the speed of light in a vacuum, when traveling through silver, gold, copper, and some other metals.

### BRIEF DESCRIPTION OF THE DRAWINGS

FIG. 1 shows a metal optical interconnection between two chips.

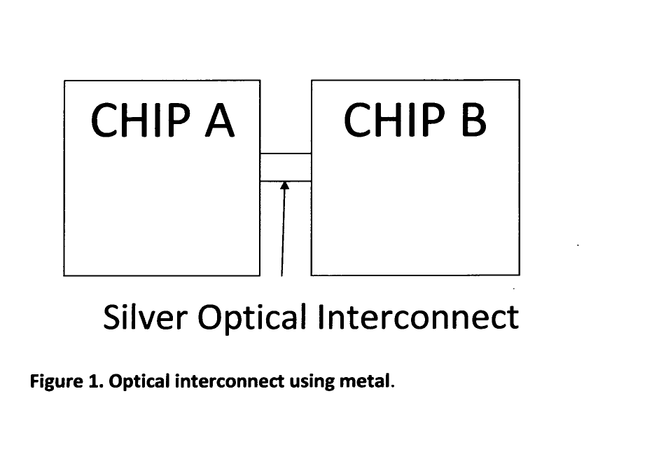

FIG. 2 shows an optical interconnection consisting of metal and dielectric layers.

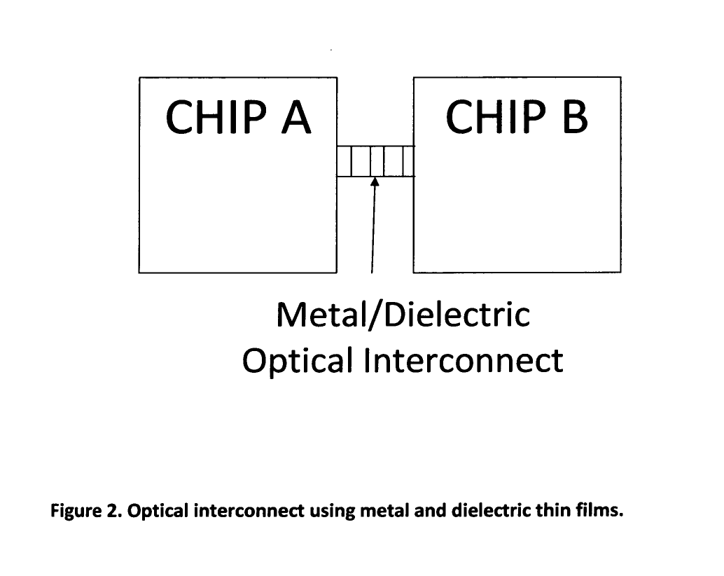

### DESCRIPTION OF THE INVENTION

As described in the book Thin-Film Optical Filters by H. Angus Macleod, third edition, Taylor & Francis, New York (2001) Ch. 2, light energy is transferred as a wave with a velocity v according to the refractive index n of the optical material following the relation v=c/n. It turns out that n for silver is less than unity. This would mean that light travels faster than c in silver. However, silver is a metal that also absorbs light, so it is not clear in the literature that the speed of light in silver would be faster than c. In fact there is a strongly held belief that light and especially information cannot travel faster than c. I have discovered theoretically that although the light is being attenuated, it does not slow down when propagating through small distances in silver and actually speeds up to many times faster than in air. With the ever decreasing distances on chips it has or will become feasible to use silver as an optical interconnect. Light in silver travels eight times faster than in air or vacuum.

The following claims are made for this invention:

1. A method for transferring signals using light propagating through certain optically absorbing materials.

2. The method of claim 1 wherein the material is a metal whose refractive index n is less than unity.

3. The method of claim 1 wherein the material is a nitride whose refractive index n is less than unity.

4. A multichip module that includes an array of integrated circuit chips that uses optical absorbing materials as optical interconnects between the chips.

5. A multichip module of claim 4 wherein the optical interconnect is a metal whose refractive index is less than unity.

6. A multichip module of claim 4 wherein the optical interconnect is a nitride or other material whose refractive index is less than unity.

7. An optical interconnect using metal and dielectric layers as the transmitting media.

8. An optical interconnect that also conducts electrical signals.
